(19) United States
(12) Patent Application Publication
(10) Pub. No.: US 2016/0003696 A1
(43) Pub. Date: Jan. 7, 2016

(54) Crank Arm Electronics Packaging

(71) Applicant: BREAKAWAY INNOVATIONS PTY LTD, Osborne Park, WA (AU)

(72) Inventors: David John Longman, Floreat (AU); Tom Peter Baskovich, Trigg (AU)

(73) Assignee: BREAKAWAY INNOVATIONS PTY LTD, Osborne Park, WA (AU)

(21) Appl. No.: 14/769,455

(22) PCT Filed: Feb. 21, 2014
(86) PCT No.: PCT/AU2014/000162

§ 371 Date: Aug. 21, 2015

(30) Foreign Application Priority Data
Feb. 22, 2013 (AU) 2013900612
Dec. 9, 2013 (AU) 2013904787

(51) Int. Cl. G01L 5/22; B62J 99/00; B62M 3/16

(52) U.S. Cl. CPC G01L 5/225; B62M 3/16; B62J 99/00; B62J 2300/002; B62J 2099/002

(57) ABSTRACT

A powermeter module (29) for a cycle crank arm includes a single cavity (320), (420) or double sided cavity/cavities (20) extending into the crank arm (12), (312), (412) and arranged to house electronics components (30), (264), 364, (464) (motherboard) and power supply components (54), (254), (354), (364) (powerboard). The powermeter electronics components are electrically connected to strain gauges (28a), (28b) e.g. by hard wires and/or plug and socket arrangement. The powermeter module components are housed in the crank arm and accessible by one or more covers (40), (48), (240), (248), (340), (348), (440), (448) for maintenance access. An associated crank arm (10) has a first cavity disposed towards a crank axis end (12) of the crank arm. A transition zone E of the crank arm material extends from either end of the cavity/cavities to provide a path for normalisation of forces passing to the strain gauge(s).

### FIELD OF THE INVENTION

The present invention relates to packaging of one or more devices in a crank arm of a crank operated system, such as a bicycle, exercise cycle or winch.

Particularly, one or more forms of the present invention relates to packaging a device to determine power input, power output, torque(s) and force(s) through a cyclic cranked system, for example, by a rider whilst riding a bicycle or using an exercise cycle.

The packaging configuration of the present invention is particularly suited to providing a versatile, robust and waterproofed arrangement, whilst meeting functional and wireless communication requirements for a bicycle powermeter system intended for outdoor use and the varying environmental conditions that that entails.

### BACKGROUND TO THE INVENTION

Whilst the present invention will be described with reference to power meters on bicycles, it will be appreciated that the present invention has applications in cyclic cranked systems where a crank arm or rotary action lever is used, such as in a manual winch.

A typical bicycle includes a pedal crank set having a pair of pedal crank arms and a pair of associated pedals, each pedal being rotatably mounted to a distal end of its respective crank arm. The efforts of a rider are translated to power though application of force to the pedals which provide a motive torque to a chain wheel or other transmission device which in turn powers a wheel or wheels of the bicycle.

“Power-meters” for bicycles are well known. Many different types of power-meters are available; examples including devices which measure and transform bicycle chain tension data into power readings, instrumented rear hub axles, instrumented chain-wheel devices, and instrumented crank axles and/or bottom brackets.

A power-meter system normally has a force or torque sensing system that measures forces or torques applied by a bike rider (either directly or indirectly as explained further below), a transformation or processing means which takes signals or data from the sensing means and manipulates the data into parameters which are displayed on a display unit and/or stored in a memory unit for subsequent display and/or analysis.

One example of known prior art is given by United States patent publication US 2010/0093494 (also published by WIPO as PCT publication WO 2008/109914). A cartridge is arranged to be releasably retained in a hollow axle of a bicycle axle. Sensor elements within the cartridge give signals corresponding to rotational angle of associated crank arms and/or torque applied thereto. The device measures pedaling forces through the axle, and is designed for use specifically with a crankset described in corresponding US patent publication US 2007/0182122 by the same applicant rather than being configured for general use and adaptability. It has been realised that left and right hand sensors close to each other within the cartridge placed within the axle may not provide accurate readings. Furthermore, no information is given about positioning sensors along the crank arms or how torque or power data might be obtain from such an arrangement.

Other examples of known power-meter systems include U.S. Pat. No. 4,463,433 and U.S. Pat. No. 5,027,303 which both describe a torque measuring system utilising strain gauges to measure the total torque input to a chain wheel by applying strain gauges to the pedal cranks, or to a chain wheel interface and a pedal crank.

It has become common practice for bicycle riders to have display units that are capable of receiving and displaying various parameters relating to the riding activity. Many of these display units have the capability to display a cycling effort related power output. However, there are drawbacks restricting a significant number of riders from adopting present power metering systems, for various reasons, including but not limited to, compromised aesthetics, sensitivity to water ingress, lack of accuracy, a requirement for regular re-calibration, the prohibitive cost and complexity of some of the available systems, or the fact that some of the systems impose a weight or other performance penalty on the bike rider and therefore would not be favoured for race related events and therefore make a purchase less likely.

Notably, only prior international patent application PCT/AU2010/001594 by the present applicant (publication number WO 2011/063468—the contents of which are herein incorporated in their entirety by reference) provides any other details as to how such an arrangement, which places strain gauges into intimate bonded contact with a surface of the crank arm, would be packaged to provide a highly accurate, low weight, robust and waterproofed system that allows ready access to data and convenience of use by the rider. This prior international patent application also provides novel teachings to allow strain gauges to be applied directly to crank arm designs so as to provide the highest levels of accuracy and which are not constrained to be of a simple rectangular or square cross-section, thus allowing considerable functional and aesthetic design freedom in the design of suitable crank arms for power meter applications.

However, it has been realised that valuable changes to the positioning and arrangement of components and the functionality of the cyclic cranked measurement devices/systems and related devices/systems, can improve one or more of water proofing, battery life, communications reliability and/or speed, and preferably reduce weight and number of components, part costs, assembly costs and also provide crank arm design freedom. It is with the aforementioned in mind that the present invention has been developed.

It is to be noted that waterproofing of a ridden cycle power meter system is a non-trivial aspect of powermeter design and operation. This is particularly so in cases where the highest accuracy of power meter capability demands that the sensors (e.g. strain gauges) are directly and intimately bonded to the crank arm. In such cases, this intimate bonding then requires that wiring connections and other components be within the external envelope of the crank.

High integrity water proofing of such systems then presents a practical challenge, which is conveniently addressed by one or more embodiments of the present invention.

Packaging of the electronics and their power supply within a crank arm is also a non-trivial matter given the size and shape constraints of a crank arm and that its strength requirements not be compromised.

The term “packaging” in the present specification is the technology of providing the arrangement of components in a size and configuration to fit the available space and design limitations, similar to the concept of packaging suspension on a vehicle (i.e. within the available spatial and operational constraints inherent on a vehicle).

Packaging considerations for a crank arm mounted powermeter are important because of the inherently limited mounting space within the envelope of a crank arm and the limited clearance between the crank arm and user/rider and frame/chainset whilst meeting functional and wireless communications requirements in a robust and highly waterproofed package. In addition, modern bicycle crank arm designs, whilst meeting functional and safety requirements, have a focus on weight reduction and attractive aesthetics.

With this in mind, it is desirable of the present invention to provide a cycle powermeter system and/or device that meets packaging constraints relating to at least one crank arm of a bicycle or other cyclic cranked system utilizing at least one crank arm, such as a static exercise cycle or manual winch.

### SUMMARY OF THE INVENTION

With the aforementioned in view, one aspect of the present invention provides a crank arm including an elongate arm member having a first end arranged to connect to a crank axis and a second end arranged to receive an applied force to operate the crank arm, and at least one cavity provided in the crank arm member, the at least one cavity intermediate the first end and the second end and extending into the crank arm member from a first cavity opening at a first external surface of the crank arm member, the at least one cavity arranged and configured to house electrical components of a powermeter, at least one of said components being accessible from the first cavity opening.

For example, one or more batteries may be inserted into the cavity from one side of the crank arm that can be later easily accessed for replacement, whilst electronic components that are essentially lit and forget′ (i.e. do not usually need maintenance or replacement) can be installed into a cavity in the crank arm on a side of the crank arm that is less readily accessible in normal use.

Consider a crank arm for a bicycle or other cycle (e.g. static exercise cycle). An electrical processor and antenna can be housed into the crank arm from a cavity opening to be on an inside face of the crank arm, and the batteries can be installed from a cavity opening on the outside face of the crank arm. The batteries and processor electrically connected through an aperture connecting the two cavity openings.

Preferably the first cavity is disposed towards a crank axis end of the crank arm relative to a pedal end of the crank arm. Thus, design geometry of the crank arm towards the pedal end of the crank arm can vary in shape and structure as required, whilst the crank axis end of the crank arm provides space for the cavity.

The at least one cavity may include at least one aperture connecting a first said cavity to a second said cavity in the crank arm member or connecting the first said cavity to a second external surface of the crank arm member.

The at least one aperture may provide a passageway through a web or partial web or at least one rib or wall of material of the crank arm member for one or more electrical connectors to pass from one cavity portion to another cavity portion or to an external portion of the crank arm or to an external housing.

The crank arm member may include a web or partial web (such as at least one raised rib) within the at least one cavity. This web or rib(s) maintaining strength in the crank arm and acting to transfer some loads applied by a user through the crank arm. The web or rib(s) also helping to ensure that strain is detected by one or more strain gauges mounted to at leafs one internal surface in the at leafs one cavity.

The crank arm incorporating the web may form what is essentially an I-beam arrangement in the crank arm. This helps transfer strain to the strain gauge(s) by providing a path for the strain through the material of the web. Also, the web stabilises the crank arm.

Preferably the web extends in a plane in the elongate direction of the crank arm member and may be substantially halfway between the first surface and the second surface.

The web or partial web or rib may be on a neutral strain axis-alignment within crank arm.

Alternatively, the at least one cavity may be a single cavity extending between the first cavity opening and second cavity opening.

It will be appreciated that the first cavity and/or second cavity opening may taper or reduce in width with progressive depth into the crank arm member. This, the two cavity openings may meet at a narrowest portion of the openings, which may include a rib or partial web as a base to each said opening.

The web may include an aperture therethrough for one or more electrical connectors to pass from one cavity portion to another cavity portion. The one or more electrical connectors may include insulated electrical wires, flexible circuit strip or shaped printed circuit board (PCB).

A first cover may be provided to protect over the first cavity opening. A second cover may be provided to protect over the second cavity opening. A seal may be provided for each cover to prevent ingress of dirt or moisture into the cavity opening which may otherwise compromise the electronics and/or power supply (batteries).

Alternatively, a first cover may be provided to protect over the first cavity opening and a potting material may be permanently applied to protect over the second cavity opening. Potting materials are used on electronic housings to enhance mechanical strength, provide electrical insulation, and enhance vibration and shock resistance of assemblies. High adhesion, non-corrosive, and thermally conductive potting products may be used. These may preferably be cured with heat, UV light, or moisture.

A seal may be provided for the first cover to prevent ingress of dirt or moisture into the cavity opening which may otherwise compromise the electronics and/or power supply (batteries).

The seal(s) may be O-ring or face seals or a combination of both. Thus, each cavity opening may include a recess to receive an O-ring and/or may include a peripheral outer surface around the respective cavity opening for a face seal to provide a seal for the cover. Likewise, the respective cover may include a recess to receive the O-ring or a face surface for the face seal.

One or both of said first and second covers may project away from the crank arm. For example, preferably the second cover protects the electronics provided in the cavity on the inside face of the crank arm that would face a cycle frame or chain set or flywheel. The projecting cover may be domed. The projecting cover may house an antenna, which antenna is therefore proud of the external surface of the crank arm and thereby provides enhanced transmission/reception capability compared with being inside the cavity surrounded by crank arm material.

The antenna may be a monopole or dipole antenna. The antenna may be provided on a PCB strip, which may be flexible PCB circuit strip. The antenna may be a patch type antenna, which may lay generally flat in-line with and adjacent the crank arm.

The at least one cavity may be positioned biased more so towards the crank axis than the force application end of the crank arm. This helps to transfer strain forces to the strain gauges as this is an area of the crank that generally has more strain applied to it. This arrangement also conveniently allows the packaging of the electronics, sensors and antenna's at a location that is generally of the largest section of the crank arm (crank arms often have a tapering section from the crank spindle end to the pedal end) and therefore is one of the strongest parts of a bicycle. Being further away from the pedal end of the crank allows reduces the risk of damage from impacts with debris and or other objects.

The at least one strain gauge may be bonded directly to the internal surface of the at least one cavity, and have electrical connections to a plug and socket arrangement or be hard wired to processor circuitry. Alternatively, the strain gauge(s) may first be bonded to a flexible or solid circuit board and subsequently bonded to the internal surface(s) of the at least one cavity.

A further aspect of the present invention provides an electronic module configured to be housed in a crank arm having at least one cavity, the module including a first portion and a second portion, the first portion receivable into a first cavity opening in a first surface of the crank arm, and a second portion receivable into a second cavity opening in a second surface of the crank arm.

Preferably the first cavity is disposed towards a crank axis end of the crank arm relative to a pedal end of the crank arm.

Preferably the first portion of the module includes electronics electrically connectable to or connected to at least one strain gauge mounted to an internal surface of the at least one cavity.

Preferably the second portion of the module includes a power supply arranged to power the electronics in the first module.

The first module portion may be hard wired to the second module portion. Electrical connection between the first and second modules may be provided by flexible printed circuit strip, which may also electrically connect to the strain gauge(s) mounted to the internal surface(s) of the at least one cavity.

The module may include at least one antenna, which is preferably housed under a cover protecting the module at one or both of the cavity openings. The antenna may be housed in the cover proud of the envelope of the crank arm external surface. Preferably this is provided on the inside face of the crank arm to be adjacent or facing the frame of a cycle.

The module may include a first cover over the first module portion when received into the cavity opening. The module may further include a second cover over the second module portion when received into the second cavity opening. Alternatively, the module may be received into the cavity from one cavity opening, and the covers provided as external protection.

Each said cover may be removable for access to the module. It will be appreciated that the cover over the electronics may be permanent or semi permanent (i.e. not readily removed) to prevent or at least restrict access to non-user serviceable electronics and the first cover over the power supply may be readily removable for power supply replacement or maintenance (such as battery replacement).

The first cover may be retained by a releasable fastener, such as a clip, catch or fastener arrangement. A slide catch (which may be biased to a latch position may be used), a resilient biasing means (such as a spring) clip arrangement may be used. Alternatively, the cover may have one or more resilient portions, such that the cover is squeezed or pried off for removal from the crank arm. One or more threaded fasteners may be used, such as a bolt through the crank arm to a retainer adjacent the second cover.

The electronics may include a processor electrically connected to the at least one strain gauge. The processor arranged and configures to receive electrical signals from the at least one strain gauge, and to provide processed signals to a transmitter. The transmitter, via the antenna, is arranged to transmit the processed signals to a remote device, such as a display or memory device, or remote processor for further processing and analysis. The processor of the module may conduct analysis of the signals received from the at least one strain gauge.

Signals received by the processor from the at least one strain gauge may related directly to detected strain values.

Signals transmitted to the remote device may relate strain through the crank arm resulting from forces applied by a user.

A yet further aspect of the present invention provides a cycle power meter system including a crank arm having at least one cavity providing a first cavity opening on one side of the crank arm and a second cavity opening on a second side of the crank arm, and a powermeter module including an electronics portion and a power supply portion.

Preferably the first cavity is disposed towards a crank axis end of the crank arm relative to a pedal end of the crank arm.

Preferably the electronics portion is received into one of the first and second cavity opening and the power supply portion is received into the other of the first and second cavity openings.

The powermeter system may be provided pre-assembled with the powermeter module within the crank arm or as discrete parts for subsequent assembly.

The at least one cavity is shaped, dimensioned and positioned in the crank arm so as to provide sufficient contact surface on at least one interior surface thereof for the strain gauge(s) to detect strain through the crank arm material. The cavity is preferably positioned towards the crank axle mounting end of the crank arm (i.e. the crank axis end of the crank arm) where the material of the crank arm tends to be thicker than at the worked or pedal end.

The cavity/cavities may be shaped so as to reduce stress raisers which would otherwise have a negative effect on the fatigue strength of the crank arm. Preferably the cavity/cavities has/have rounded/radiused corners rather than square or 90° corners to assist with strain force transfer to the strain gauges.

The cavity/cavities may be arranged and configured to allow sufficient transition distance either side of the sensors to ensure that the strain is well developed and not sensitive to small changes in the geometry of the crank arm which can occur as a result of manufacturing tolerances. Embodiments of the present invention seek to minimise dimensions of the cavity within the envelope of minimum transition distances as described above.

For example, once strain gauges are positioned in the respective cavity, a transition zone is provided for strain to normalise along the crank arm to the strain gauge(s).

By the term ‘normalise’ the present specification means that for a given force input at the pedal end the strain signal at the sensor (strain gauge) is independent of the geometry of the crank outside the envelope of the transition zone. Freedom of design of the crank arm is therefore provided outside of the transition zone.

The cavity/cavities may be elongate with respect to the longitudinal extent of the crank arm, and may have walls parallel to the longitudinal extent of the crank arm. Preferably the parallel walls support the strain gauges.

Radiused, curved or semicircular walls at one or both ends of each cavity provides are very good surface for O-ring sealing, such as for the cover o-ring.

Preferably the at least one cavity in the crank arm has a width within the range 12-20 mm with respect to the transverse width of the face of the crank arm and 26-40 mm long with respect to the length of the crank arm.

The crank arm may include at least one cavity to house one or more of strain gauge(s), electronics and wireless communication means, the cavity being no more than 40 mm in length and no more than 20 mm in width and located within a torque transmission region of the material of the crank arm. The torque transmission region may preferably be towards the crank axis end of the crank arm.

One or more physical projections may be used to maintain preferred separation between the electronics and transmitter boards. Such projections (or ‘standoffs’) help to stabilise the transmitter board and/or the electronics board to prevent physical distortion which can otherwise cause or introduce signal error from the strain gauges or in the signal passed to the transmitter from the electronics board. Preferably the projection(s) or ‘standoff(s)’ is/are off an electrically insulating plastic material, such as nylon. Beneficially the projection(s) avoids off centre, and thereby uneven, loads on and prevents ‘rocking’ of the electronics board, which helps to ensure a clean signal to the transmitter by avoiding physical distortion which otherwise could create signal distortion.

A resilient material, such as a foam, may be provided between at least one of the covers (e.g. battery and/or electronics module covers). The resilient material applies a retaining pressure on the transmitter board without damaging or distorting that board. Preferably the resilient material is mounted over a spigot attached or forming part of inside of the cover and which spigot passes through a central aperture in the transmitter board thereby physically locating the transmitter board in its required position.

Preferably there are soldered connections, such as soldered pin connections, from the battery module onto the electronics board and/or vice versa.

A washer or spacer may be provided between the electronics board and the web, and which is preferably a double sided adhesive tape to cushion and preferably insulate between the electronics board and the metal of the web.

A retaining stud may be provided having an externally threaded stud portion that extends through the web, through the washer and through a central aperture in the electronics board to engage with a threaded aperture in the spigot of the cover of the electronics module. Thus, the electronics module is secured in place within the cavity. The retaining stud may have an internally threaded aperture on the battery module side.

Preferably a locking device prevents the threaded stud rotating beyond a preferred maximum torque within the spigot of the cover and thereby prevents stripping of one or both of the mutually engaging threads. The locking device preferably engages on a head portion of the threaded stud once the threaded stud is tightened up to a required amount.

A light may be provided through one or more of the covers. Preferably the or each light is an LED light source, which preferably is provided within a light tube. The light can provide a visual indication of battery power condition and can be controlled to indicate one or more faults or status of the powermeter, such as low battery power, electronics or transmitter faults etc., and/or may provide an output signal related to a cadence event, preferably only during an initial or limited period of operation of the system to minimise battery drain. For example, the indicator light may illuminate for a period of time (steady or flashing as specified during manufacture or set-up) to indicate when fresh batteries have been installed correctly.

Preferably, as a cadence indicator, the light may illuminate for a period of time, e.g. say 5 minutes, from initial use and then revert to an un-illuminated ‘off’ condition. After, a period of no pedalling, e.g. say 5 minutes, the light will illuminate as a cadence indicator again for a period of time e.g. 5 minutes and then go off.

A grounding connection such as a metal spring (e.g. a metal spring washer) may be provided to help to connect and conduct electricity from the batteries to the electronics board across the web. Preferably the left and right cranks are supported on a spindle which is also electrically conductive (as is typically the case with alloy or steel spindles) so as to provide a common electrical ground for both crank arms.

Preferably a spacer is situated between the plate of the battery module and the internal web of the crank arm. The spacer preferably helps to cushion the battery module against the web and to provide an even, stable surface to ensure reliable battery connections and performance of the module.

The or each strain gauge may be pre-assembled with electrical connection to the electronics board, and press fitted into contact with the side wall(s) of the cavity. However, it is preferred that the strain gauge(s) is/are bonded to the side wall(s) for improved accuracy and repeatability of detecting strain signals.

It will be appreciated from the embodiments described above that the crank arm can have a single cavity extending a substantial distance into the outer envelope of the crank arm and arranged to receive therein at least part of a powermeter module. The power supply, electronics and antenna portions can all be provided on the cavity opening side of the crank arm, preferably with the antenna portion outermost for transmission/reception purposes.

Alternatively, for such a single cavity arrangement, electrical connection can be provided through an aperture in a side wall portion of the crank arm, and the antenna portion can be mounted on the opposite side of the crank arm to the cavity opening.

A further form of the present invention provides a double cavity arrangement, which is preferably formed by cavities on opposed sides of the crank arm, e.g. opposite one another with a web, partial web or rib of crank arm material between the bases of the cavities, and therefore there can be a passage or substantial opening between the two cavities. Alternatively, the two cavities can be side by side on the same side of the crank arm and connected by a laterally positioned web, partial web or rib of crank arm material at the adjoining side connection between the two cavities.

Thus, the power supply portion and the electronics portion can both be inserted into the same cavity on one side of the crank arm, and preferably either have the antenna portion mounted on top of that ‘stack’ so that the antenna portion is outermost with respect to the crank arm, or the antenna portion can be mounted onto the opposed surface of the crank arm on the opposite side of the crank arm from the cavity, or can be partially/completely inserted into a second cavity in that opposed second face of the crank arm. A retainer may be provided to extend around the crank arm member to help retain the module components together. For example, a resilient member may clip around or wrap around the crank arm member to act as a fastener releasably holding the parts of the power meter module onto or within the crank arm. The resilient member may form a moisture/dirt barrier to protect the powermeter module.

Earthing/grounding can be provided by connection of the electronics portion to the crank arm. The crank arms of a cycle can both be grounded to a common earthing point or feature.

An alternative form of the present invention provides a cycle power meter system, including a crank arm having at least one cavity providing a first cavity opening on at least one side of the crank arm, and the at least one cavity housing an electronics portion or a power supply portion of a powermeter module, or housing an electronics portion and a power supply portion of the powermeter module.

The crank arm may have the first cavity opening and a second cavity opening on opposed faces of the crank arm. Thus, the crank arm can have a double cavity arrangement, with the cavities ‘back-to-back’ through the crank arm. These cavities may be separated by a rib or web of crank arm material, which may have an aperture therethrough for electrical connections to pass.

Preferably the module provides the electronics portion received into the first cavity opening and the power supply portion received into the second cavity opening. However, the electronics portion and the power supply portion may be received into the first cavity opening, and optionally an antenna portion may be mounted partially or completely externally of the crank arm, and on the same side of the crank arm as the opening into the cavity or mounted on the opposed side of the crank arm.

Thus, a portion of the powermeter module may be mounted at least partially externally of the crank arm, and electrical connections through the aperture to that portion of the power meter. In respect of a single sided cavity i.e. with its predominant opening facing to one side of the crank arm, it will be appreciated that placement of the strain gauges or sensors within the cavity will take into account the asymmetrical nature of the single-sided cavity crank arm. Earlier international patent application number PCT/AU2010/001594, published as WO 2011/063468, (the contents of which are incorporated herein in their entirety) provides guidance on and discloses the applying strain gauges to non-symmetrical crank arms.

### BRIEF DESCRIPTION OF THE DRAWINGS

One or more embodiments of the present invention will hereinafter be described with reference to the accompanying figures, in which:

FIG. 1 shows a crank arm with a double sided cavity to receive components of a powermeter module according to an embodiment of the present invention in exploded view.

FIG. 2 shows the crank arm and the powermeter module components in exploded view according to an embodiment of the present invention and rotated through ninety degrees relative to the view shown in FIG. 1.

FIG. 3 shows a cross section in perspective of the view shown in FIG. 1.

FIG. 4 shows a cross section in perspective of the view shown in FIG. 2.

FIG. 5 shows a cross section through an assembly of crank arm and electronics and power supply modules according to an embodiment of the present invention.

FIG. 6 shows an alternative cross sectional view through an assembly of crank arm, spider and electronics and power supply modules according to an embodiment of the present invention.

FIG. 7 shows, as an example of the assembly arrangement, an embodiment of the present invention in the form of powermeter module components with electronics module and power module absent the crank arm.

FIG. 8 shows a crank arm according to an embodiment of the present invention.

FIG. 9 shows a crank arm and chainwheel spider, with a powermeter module mounted in the crank arm according to an embodiment of the present invention and showing a removable battery cover giving access to the batteries from the outside face of the crank arm.

FIG. 10 shows a crank arm and chainwheel spider in reverse view to that shown in FIG. 9, with a powermeter module mounted in the crank arm according to an embodiment of the present invention and showing an antenna cover on the inside face of the crank arm.

FIG. 11 shows an alternative embodiment of a module of the present invention.

FIG. 12 shows an alternative embodiment of a crank arm of the present invention.

FIG. 13 shows an exploded view of a module according to an embodiment of the present invention.

FIG. 14 shows a crank arm with a double sided cavity to receive components of a powermeter module according to an alternative embodiment of the present invention in exploded view.

FIG. 15 shows the crank arm and the powermeter module components in exploded view according to an alternative embodiment of the present invention and rotated through ninety degrees relative to the view shown in FIG. 14.

FIG. 16 shows a cross section in perspective of the view shown in FIG. 14.

FIG. 17 shows a cross section in perspective of the view shown in FIG. 15.

FIG. 18 shows a cross section through an assembly of crank arm and electronics and power supply modules according to an alternative embodiment of the present invention.

FIG. 19 shows an alternative cross sectional view through an assembly of crank arm, spider and electronics and power supply modules according to an alternative embodiment of the present invention.

FIG. 20 shows, as an example of the assembly arrangement, an alternative embodiment of the present invention in the form of powermeter module components with electronics module and power module absent the crank arm.

FIG. 21 shows a crank arm according to an embodiment of the present invention.

FIG. 22 shows a crank arm and chainwheel spider, with a powermeter module mounted in the crank arm according to an alternative embodiment of the present invention and showing a removable battery cover giving access to the batteries from the outside face of the crank arm.

FIG. 23 shows a crank arm and chainwheel spider in reverse view to that shown in FIG. 22, with a powermeter module mounted in the crank arm according to an alternative embodiment of the present invention and showing an antenna cover on the inside face of the crank arm.

FIG. 24 shows an alternative embodiment of a module of the present invention.

FIG. 25 shows an alternative embodiment of a crank arm of the present invention.

FIG. 26 shows an exploded view of a module according to an alternative embodiment of the present invention.

FIG. 27 shows an alternative embodiment of the present invention mounted in a single cavity of a crank arm and with an antenna on a non-cavity side of the crank arm.

FIG. 28 shows a further alternative embodiment of the present invention with part of a power meter module mounted in a single cavity of a crank arm and with an antenna provided on the cavity side of the crank arm.

### DESCRIPTION OF PREFERRED EMBODIMENT

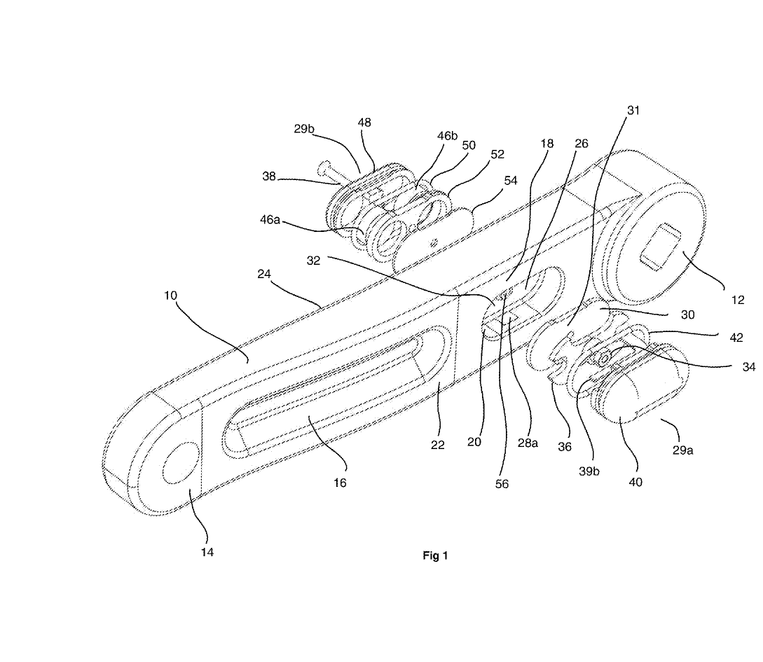

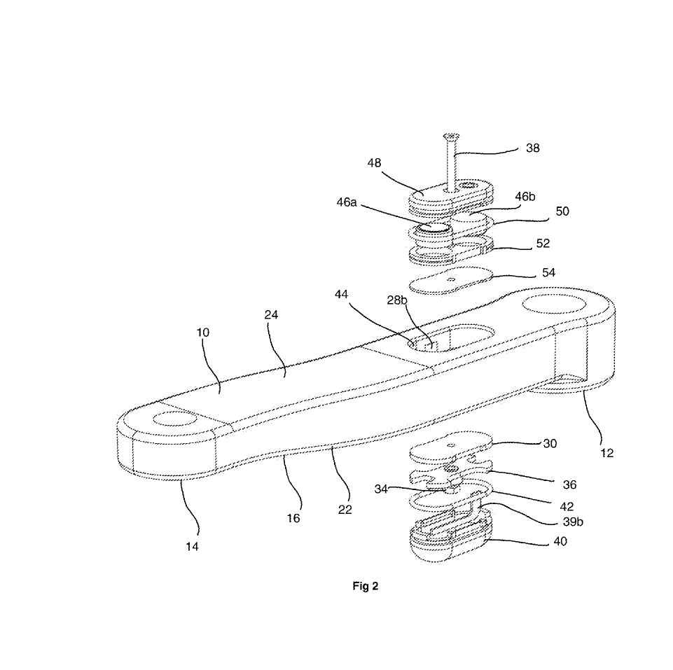

FIGS. 1 and 2 show a crank arm 10 with a crank mounting end 12, a pedal mounting end 14 and a weight reducing recess 16. A section 18 of the crank arm towards the crank mounting end includes a double sided cavity 20 accessible from an inside face 22 and an outside face 24 of the crank arm. To explain, on the right hand crank arm (relative to facing forward on the bike or other cycle) the inside face 22 is the face of the crank arm that faces towards the bike frame when in use, and the outside face 24 that faces away from the bike frame when in use. Thus, on the chainwheel side of the frame, the inside face of the crank arm is on the chainwheel side of the crank arm and the outside face is on the opposite side of the crank arm facing away from the chainwheel. Likewise, on a non-chainwheel side (the left hand) crank arm (on the opposite side of the frame) the inside face faces towards the frame and the outside face faces away from the frame.

In the embodiment shown in FIG. 1, the cavity 20 is divided by a web 26 of the crank arm material. Thus, the crank arm can be machined or cast with a double sided cavity but retain a web of material for strength and to assist with transferring strain through the crank arm to be detected by one or more strain gauges 28a,28b applied within the cavity. It will be appreciated that the number and position of the strain gauges within the cavity can be varied to suit particularly applications, though at least one is provided.

It will further be appreciated that the strain gauge(s) can be mounted onto flexible circuit strip and then bonded to the wall of the cavity. Alternatively, the stain gauge(s) can be bonded to the wall of the cavity and electrical connections made to them by miniature plug and socket connection or permanent hard wiring.

A powermeter module 29 has an electronics portion 29a and a power supply portion 29b.

Electronic circuitry 30 of the powermeter module 29 is received into the cavity opening 32 on the inside face of the crank arm. The electronic circuitry can be on a printed circuit board (PCB) as shown in FIG. 1, or on a flexible circuit strip. A cadence switch 31 is mounted to the PCB. This cadence switch is preferably a magnetically operated reed switch that operates when it passes a magnet mounted to the cycle frame during cycling.

A nut 34 is retained behind a retainer plate 36. The retainer plate and PCB 36 have respective apertures therethrough for the threaded end of a bolt 38 to pass through to threadingly engage with the nut. The fastener also passes through an aperture 56 in the web 26. The retainer plate supports the nut and transfers clamping loads to the crank arm and prevents damage to the PCB when the bolt is tightened from the outside face.

A cover 40 (first or inside cover) seals the opening to the cavity on the inside face. A seal 42 seals between the cover and the crank arm. The seal prevents ingress of dirt and moisture via the inside face cavity opening. The seal may be an O-ring that sits in a groove around the cavity opening or may be a face seal that seals the cover at the flat surface of the inside face. Alternatively the seal may be incorporated as an integral part of the cover. A further alternative comprises a permanent gluing or sealing of the cover 40 for applications where this cover does not require removal once installed.

The cavity aperture 44 into the outside face 24 of the crank arm receives the power supply components. In the embodiment shown in FIG. 1, the power supply is via two batteries 46a,46b. These batteries are protected externally by a further cover 48 (second or outside cover) over the opening to the cavity from the outside face. A seal 50 prevents ingress of dirt and moisture to the batteries from the outside face cavity opening. The seal my be an O-ring or face seal. Alternatively, the seal may be incorporated as an integral part of the cover.

The batteries sit in a cradle 52 for support and electrical connection. It will be appreciated that whilst two batteries are described, other arrangements and configurations of power supply are possible within the scope of the present invention. For example, a single battery may be provided.

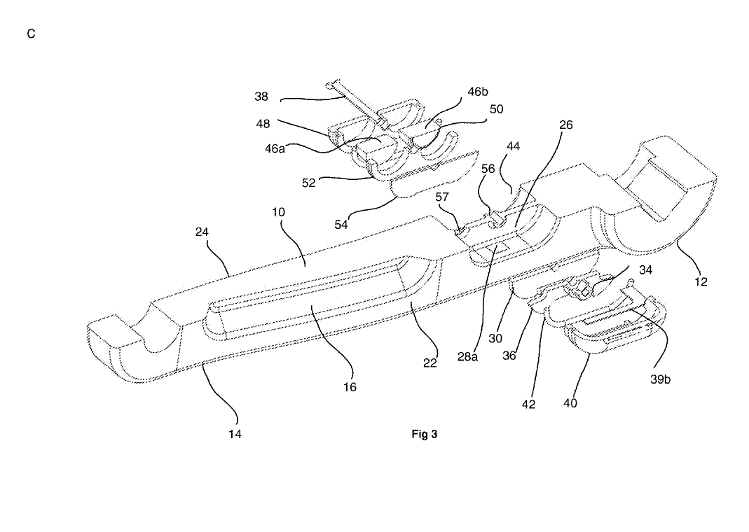

Electrical connection is provided through an aperture 57 (FIG. 3) in the rib 26 so that the batteries can power the electronic circuitry.

An insulating plate 54 provides electrical insulation between the batteries and the metal of the rib of the crank arm.

An antenna 39 connected to the electronic circuitry is preferably housed under the cover 40 on the inside face of the crank arm. This cover can preferably be domed or otherwise project away from the crank arm so that the antenna 39 housed therein is away from the metal of the crank arm and thereby has an improved line of transmission to an external receiver, such as a display or data processor.

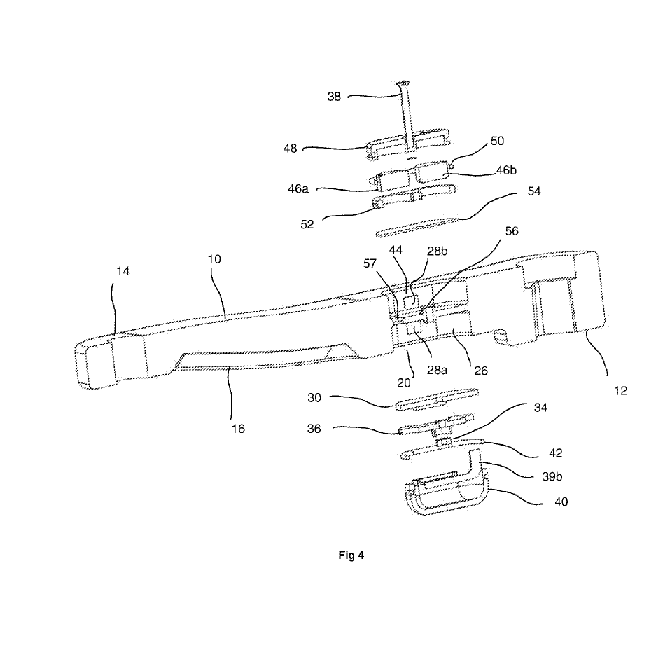

FIGS. 3 and 4 show respective cross sections of FIGS. 1 and 2 with components numbered the same accordingly.

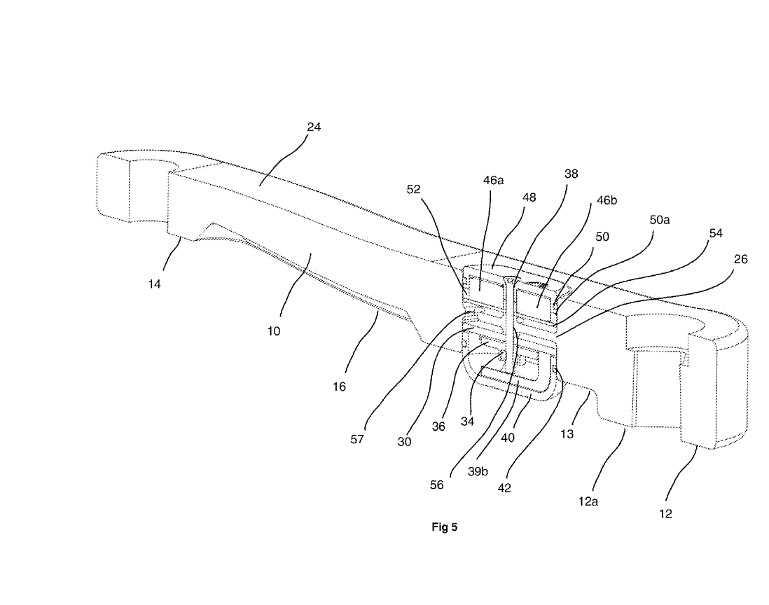

FIG. 5 shows a cross section through an assembly of crank arm and electronics and power supply modules. Reference numerals are the same as mentioned above. The domed inside cover 40 over the antenna 39 does not project further than the height of the boss 12a of the crank end 12 of the crank arm 10 with respect to the elongate body portion 13 of the crank arm between the crank end and the distal (worked) end 14 where (pedal) force is applied by a user. Thus, the cover 40 allows the antenna to project above the potentially shielding metal or other material (such as carbon fibre) of the crank arm body portion for effective transmission purposes, whilst also clearing any frame or chainset components of the cycle.

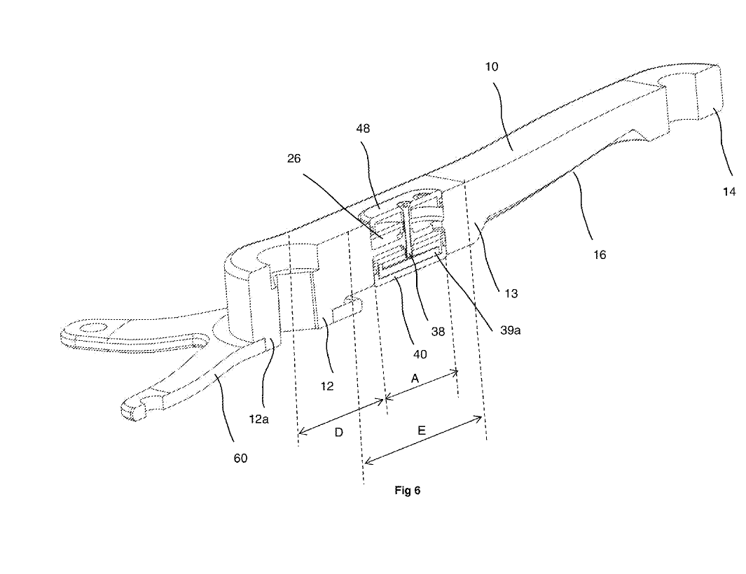

FIG. 6 shows a similar assembly to that of FIG. 5. However, the inside cover 40 projects less and the crank arm is shown mounted to a spider 60.

In operation, in one particular embodiment, the right hand crank arm powermeter acts as a “slave” and has a communication channel open to the left hand crank arm powermeter which acts as a “master”. The left hand master powermeter receives data from the slave powermeter, combines it with its own data and has a communication channel open to transmit the data to an external data acquisition and/or display device (not shown).

Thus, the right hand crank arm can have an electronics module in a cavity therein, and which transmits data via its antenna 39a to be received by a corresponding antenna 39b of an electronics module housed in the left hand crank arm.

In this arrangement, the wireless transmission distance between the slave and the master is of the order of 200 mm. This relatively short transmission distance, and the fact that the antennas 39a,39b are diametrically opposed across the crank axle, allows a compromise of the packaging of the antenna of the right hand crank powermeter system in that the housing above this antenna may be reduced in height, or indeed made flush or even recessed to the inner surface of the crank arm. This allows additional design freedom in and around this area of the crank arm which can be useful to a designer in terms of the chain wheel spider design.

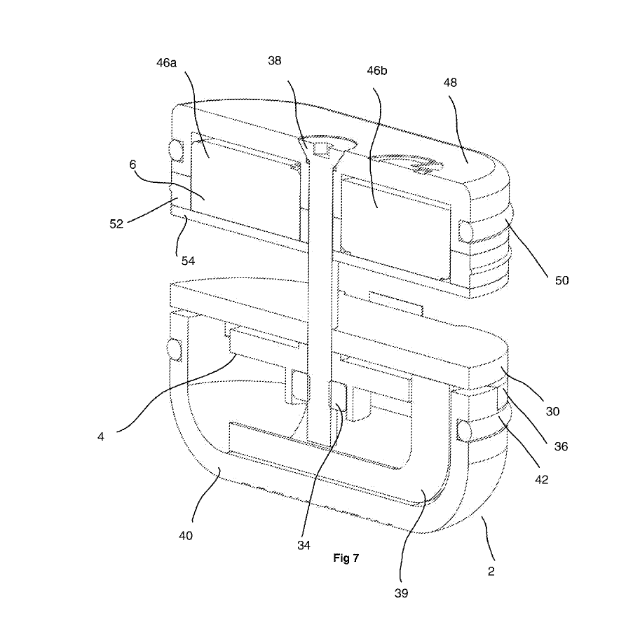

FIG. 7 shows, as an example of the assembly arrangement, an embodiment of the present invention in the form of the powermeter module 2 components with electronics module 4 and power module 6 portions, and absent the crank arm 10.

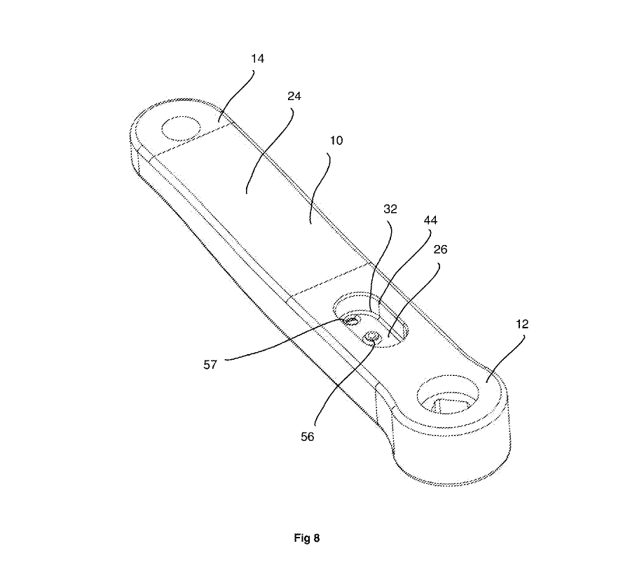

FIG. 8 shows an embodiment of a crank arm of the present invention. A central web 26 of crank arm material extends longitudinally across the cavity opening 32 with respect to the longitudinal extent of the elongate crank arm. The web has an aperture 44 to allow electrical connection between one side of the cavity and the other. This allows hardwired electrical connection between the power supply (when inserted into the cavity) and the electronics (when inserted into the inside face side cavity).

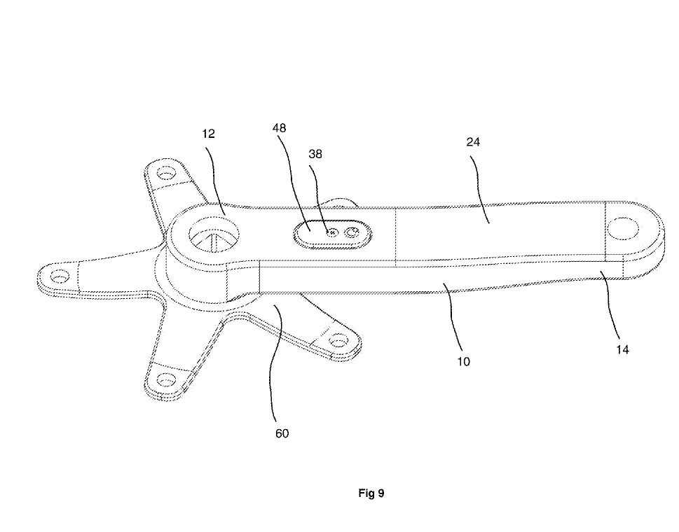

FIG. 9 shows a crank arm 10 and spider 60 in perspective. The outside face cover 48 is shown in position with the retaining bolt 38 tightened to retain the cover. As can be seen, the entire powermeter module is neatly and discretely packaged into the crank arm with a low profile providing minimal risk of damage when in use, minimum aesthetic and physical intrusion, and yet easy access to replace or check the batteries even when the crank arm is mounted to a cycle.

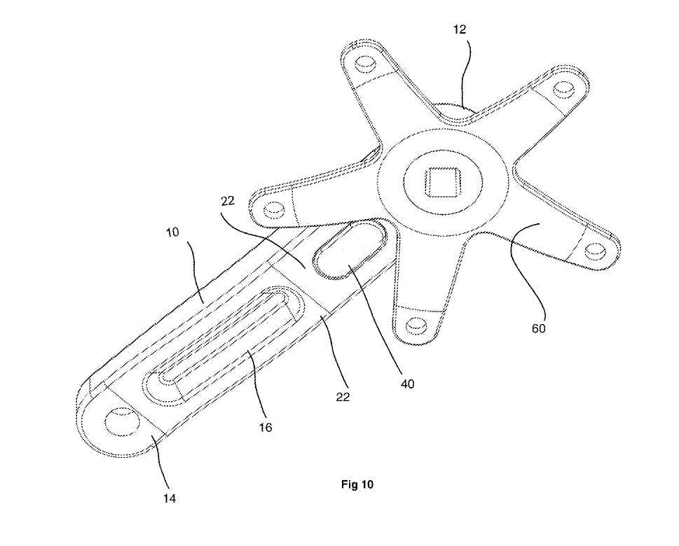

FIG. 10 shows the inside face 22 with the inside face cavity cover 40 in place. The cover clears the spider and chainset when in use but provides sufficient height for good antenna transmission/reception.

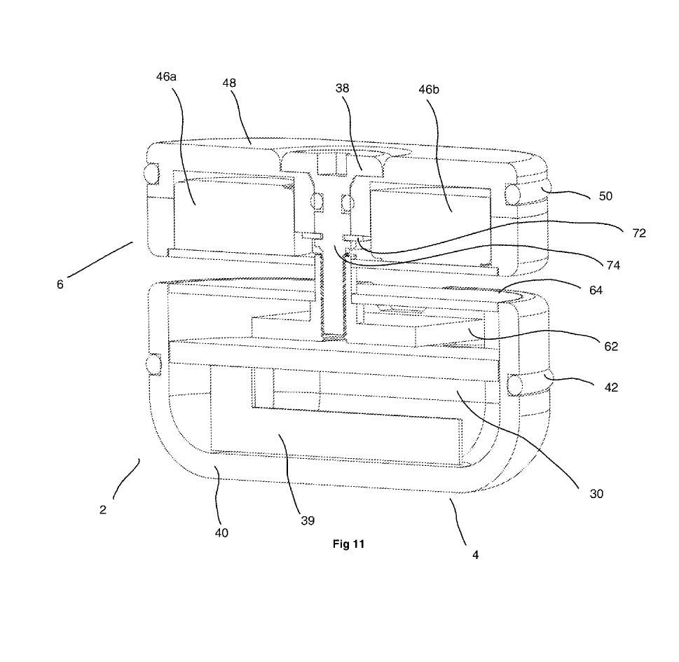

FIG. 11 shows an alternative embodiment of a powermeter electronics module 2 with electronics 4 and power 6 portions. It will be appreciated that the module may have power and electronics combined in one portion, such as a module that inserts as a one piece unit into one side of the crank arm cavity and with a single removable external cover.

As shown in FIG. 11, the fastener 38 may connect through the module portions to a retainer 62, with a radio/RF transmitter PCB 30 provided outboard of the retainer 62 rather than the inboard retainer 36 shown in previous embodiments. Thus, no aperture needs to be provided through the PCB in this embodiment for the fastener. A microprocessor PCB 64 is also provided which will communicate processed strain signals to the radio/RF section for transmission to another (master) module or remote device, such as a display or computer or memory device.

The fastener 38 in the embodiment shown in FIG. 11 has a retainer 72. In this embodiment, the retainer is in the form of a circlip that allows the fastener to rotate, but abuts a flange 74 on the circlip to ensure the cover 48 is removed when the fastener is released and also removed i.e. the cover comes off with the fastener and they remain together. The antenna 39 will be proud of the external surface of the crank arm when the cover and electronics are in position in the cavity. This provides for good communication reliability to an external receiver.

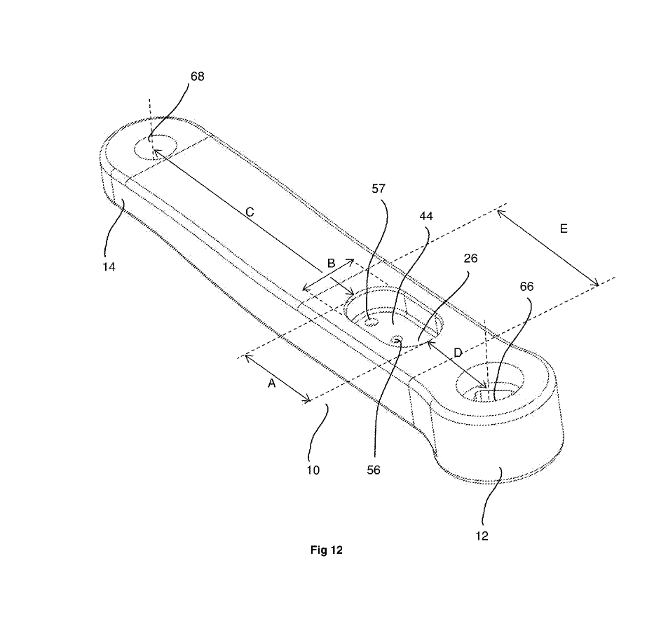

FIG. 12 shows an embodiment of a crank arm 10 of the present invention, with exemplary dimensions A (length) and B (width) of the cavity showing the preferred proportions of the cavity relative to the extend and width of the crank arm and position of the cavity relative to the ends 12,14 of the crank arm and crank pivot centre 66 and pedal pivot centre 68. Preferably the cavity is disposed towards the crank axis end of the crank arm relative to the pedal end of the crank arm. This beneficially provides the cavity in a strong section of the crank arm where strain can be detected and the strain gauges have contact with sufficient cavity interior surface whilst there is also sufficient material of the crank arm remaining around the cavity to transfer strain.

The web 26 in the crank arm cavity 44 includes two apertures, although more apertures may be used. Alternatively, a single aperture may be used for receiving a fastener therethrough and/or electrical connections. A first aperture 56 allows the fastener 38 to pass through to the other cavity portion. The second aperture 57 allows for electrical (hardwire) connection between the power and electronics modules.

As shown in FIGS. 6,12,19 and 25, but present in other figures as well, the cavity, which applies to the cavity on one side or the other of the crank arm or both sides of the crank arm, may have dimensions A & B, with A indicating the length and B indicating the width. Preferably A is within the range 26 mm-40 mm and B is within the range 12 mm-20 mm, and that the cavity is positioned towards the crank axis end 12 of the crank arm to provide effective torque force transfer through the material of the crank arm to the strain gauges positioned on the inside surface(s) of the cavity. Thus, dimension C is preferably significantly larger than dimension D.

Dimension E, as shown in FIGS. 6,12,19 and 25, shows the transition zone (also present in other figures) extending either end of the cavity/cavities, within which zone forces normalise as they enter the transition zone from the pedal axis end of the crank arm and pass through the material of the crank arm around the cavity/cavities (and through any web of material between cavities, if present) and pass out of the transition zone to the crank axle axis.

It will be appreciated that the transition zone is within the material of the crank arm and is therefore a 3-dimensional volume of the crank arm material and not just a surface area. The transition zone provides a volume of known shape and size of crank arm material which allows the forces detected by the strain gauge(s) to normalise, and essentially ‘smooth out’ prior to reaching the strain gauge(s) before passing through to the crank axle.

Preferably the transition zone extends longitudinally along the crank arm a required or predefined distance from each end of the cavity/cavities. For example, preferably the transition zone extends a distance of 10 mm from each edge of the cavity towards, respectively, the crank axle end and the pedal end of the crank arm. The required or predefined distance may be determined by the type of and density of the material of the crank arm, and optionally the cross-sectional shape of the crank arm. As an example given in a specific embodiment of the present invention, the transition zone extends approximately or substantially 10 mm away from each end of a 36 mm long cavity positioned towards the crank axis end of the crank arm such that the distance from the edge of the cavity towards the centre of the pedal axis of the crank arm is significantly greater than the distance from the edge of the cavity to the centre of the crank axis of the crank arm.

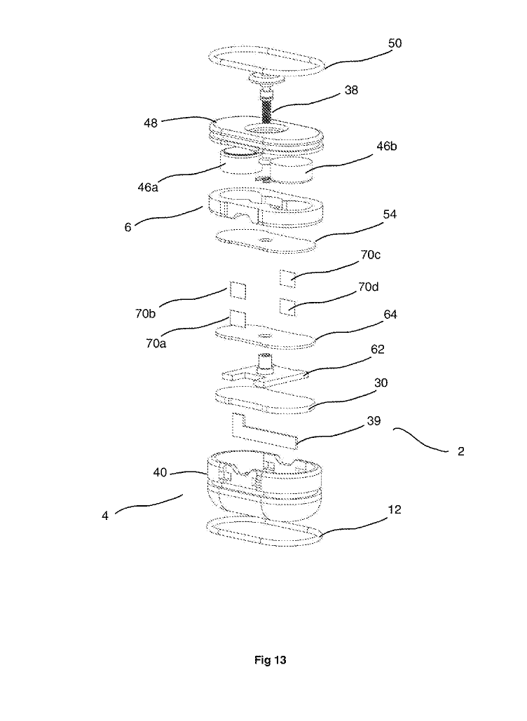

FIG. 13 shows an exploded view of an alternative embodiment of the electronics module of a power meter data gather device and exemplary strain gauges. The module 2 includes an electronics portion 4 and a power portion 6. The electronics portion includes a cover 40 over electronics 30 providing a radio/RF section outboard of the retainer plate 62. The radio/RF section is electrically connected to an antenna 39. An O-ring seal 42 is provided to seal the cover and electronics from ingress of dirt or moisture when in the crank arm cavity. A retainer plate 62 receives an end of the threaded fastener 38 to retain the removable power portion cover 38. A microprocessor circuit board 64 is provided for the electronics portion to process signals from the strain gauges 70a-70d.

The power portion 6 has a cover 48 over a pair of cell batteries 46a,46b that sit in a cradle 52. An O-ring 50 seals the cover 48 when the power portion 6 is inserted into a cavity in the crank arm. A plate 54 covers the battery cradle and provides electrical insulation. It will be appreciated that electrical connection between the power portion and the electronics portion can be provided by hard wiring, which wiring would pass through an aperture in the web or partial web.

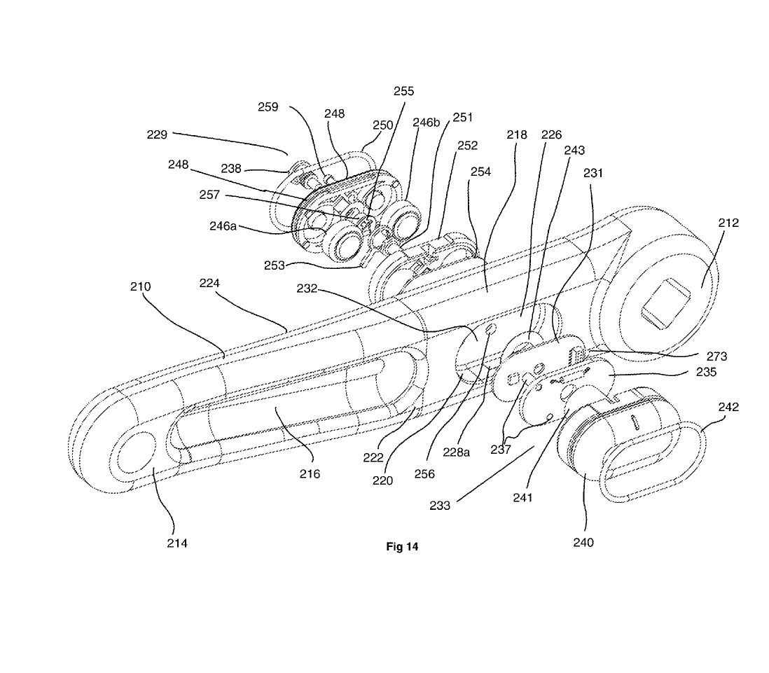

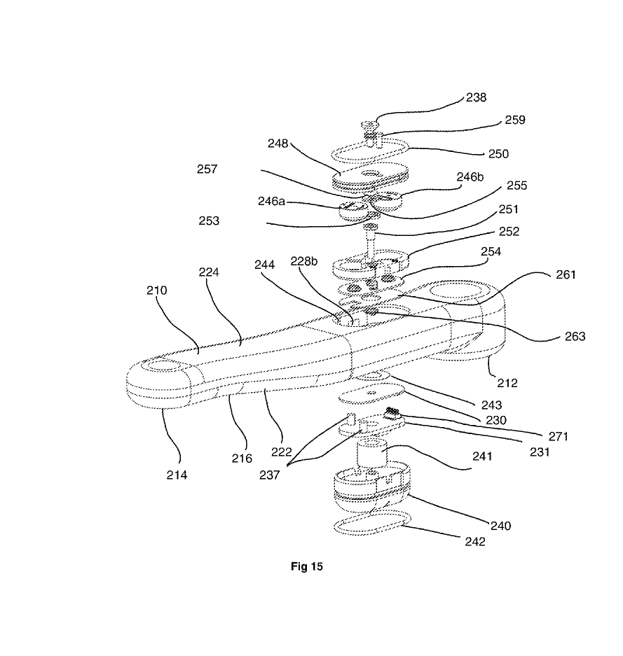

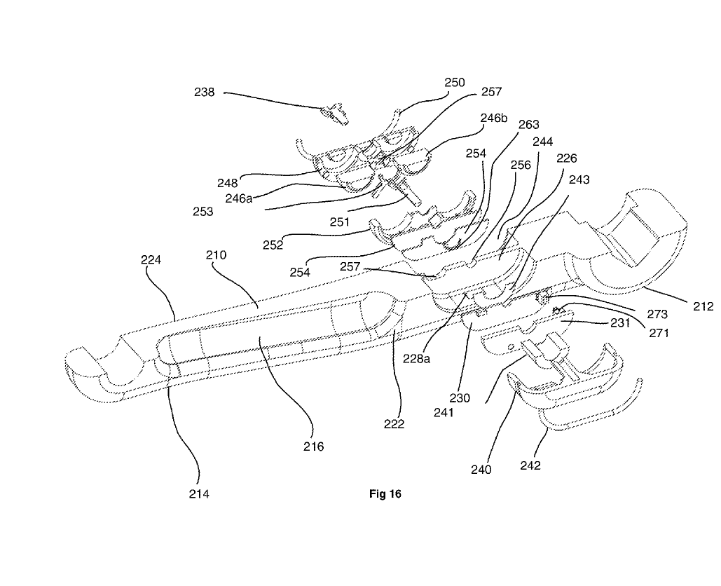

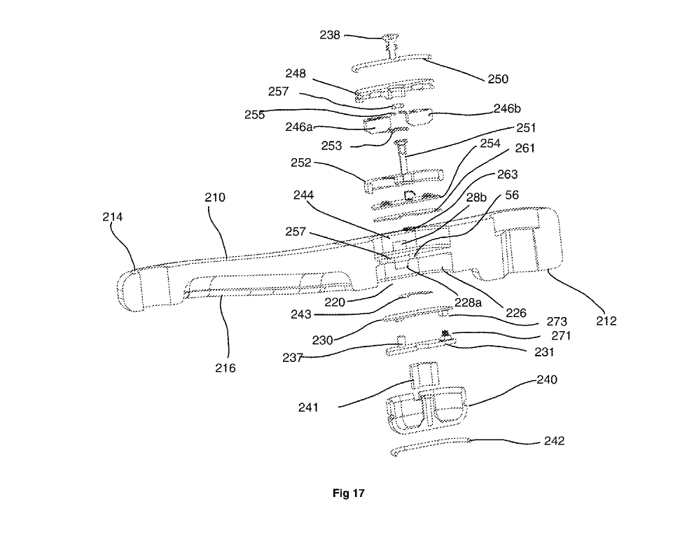

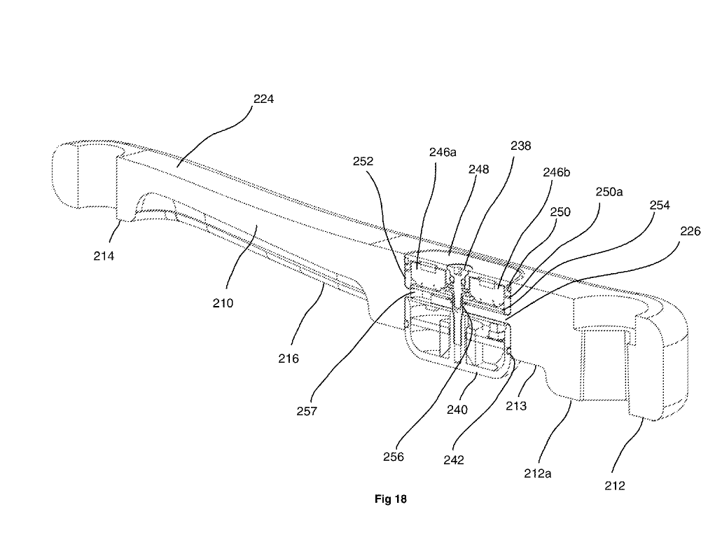

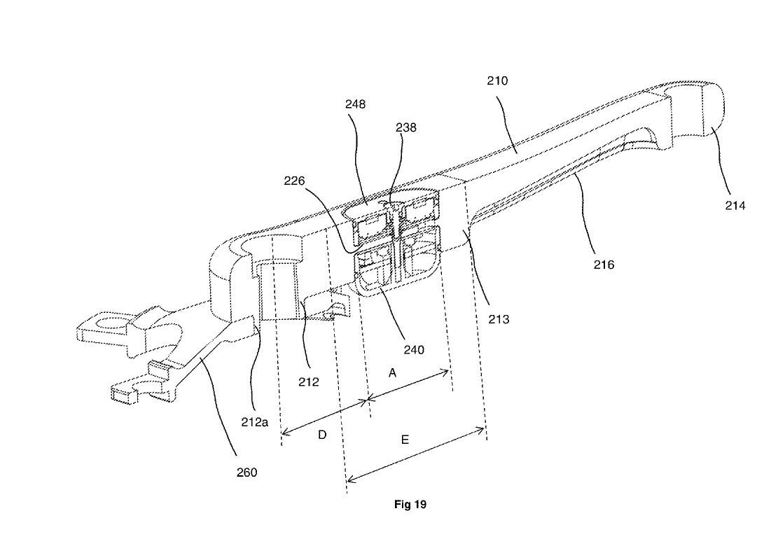

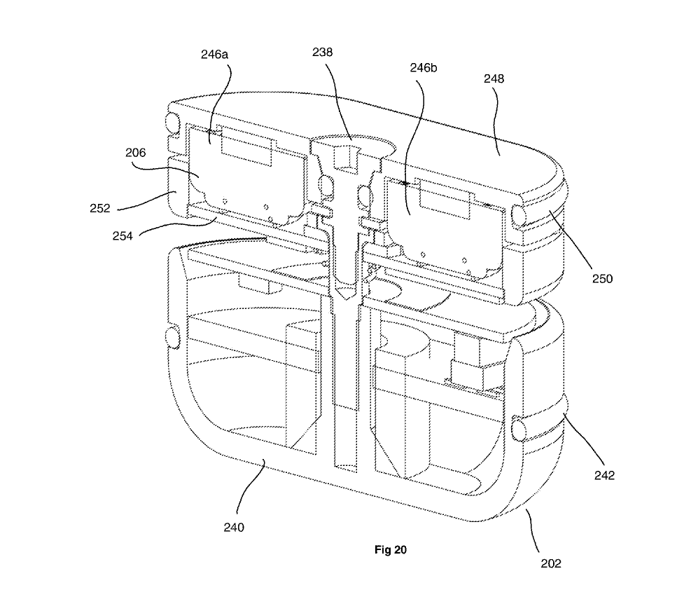

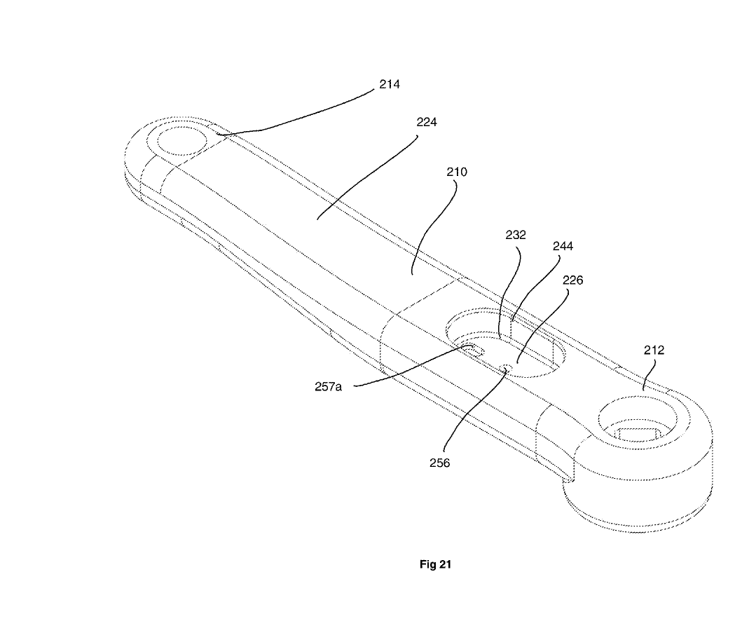

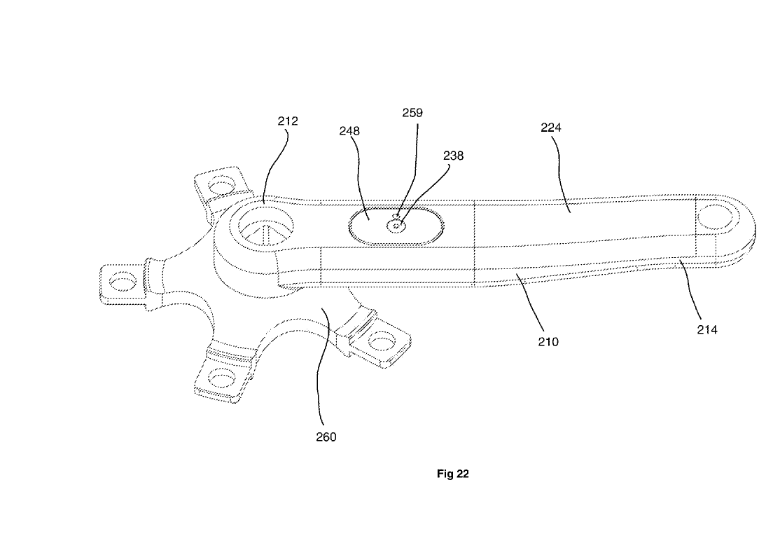

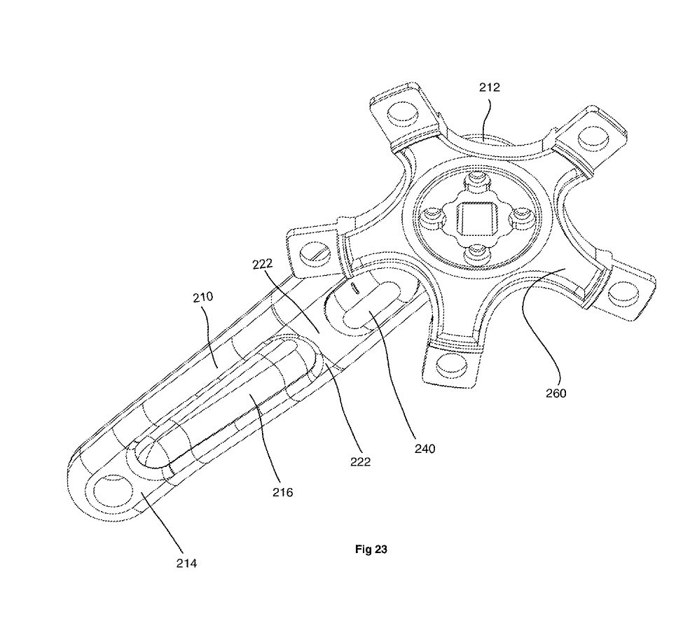

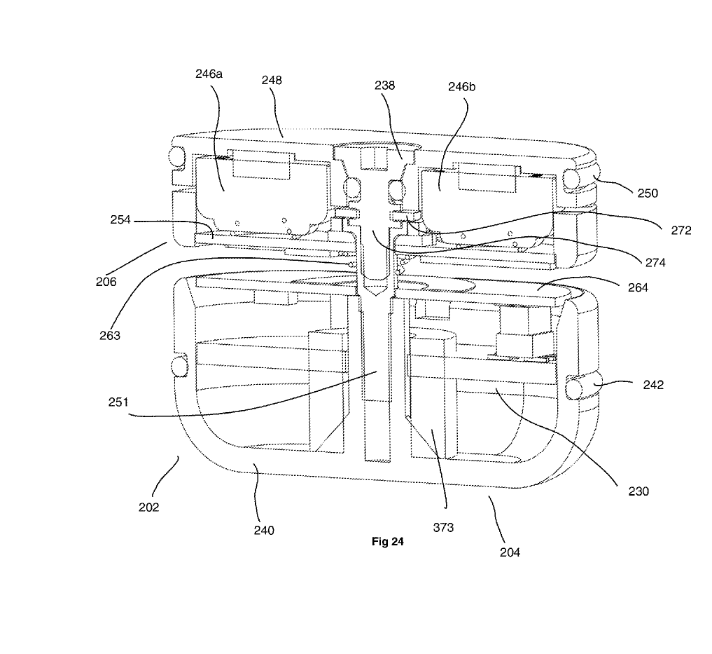

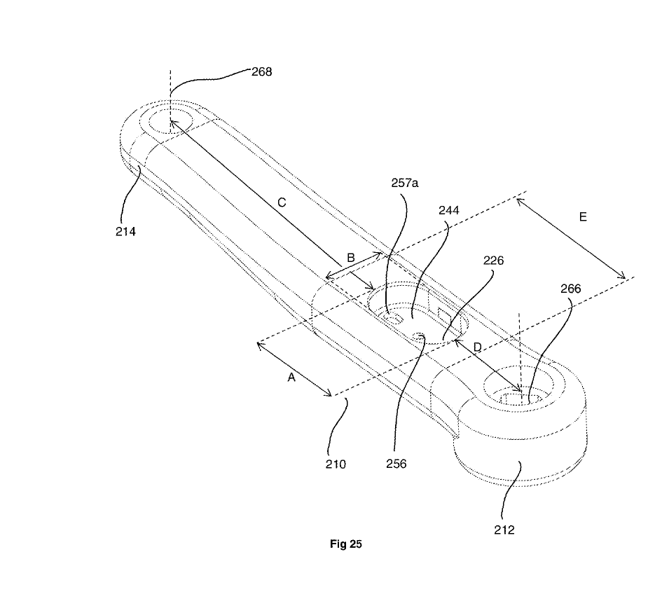

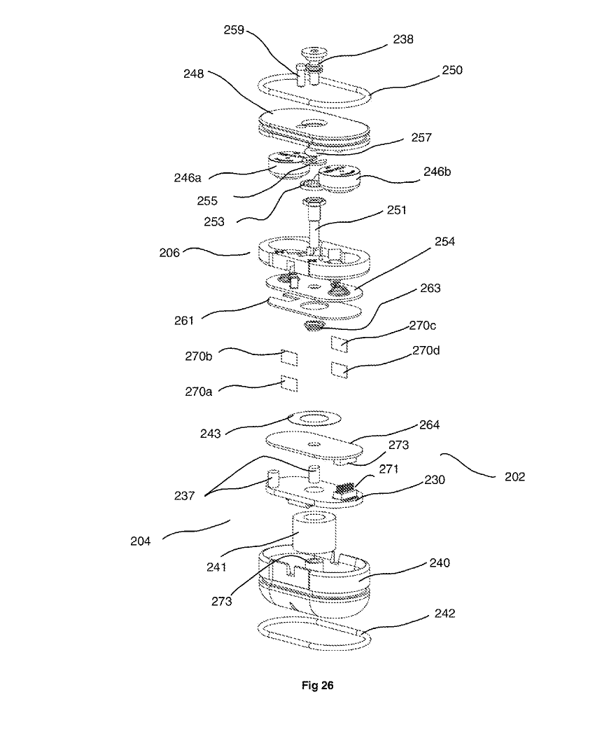

FIGS. 14 to 26 show features of an alternative embodiment of packaging for a cycle powermeter module. The crank arm 210 has a double sided cavity 220 with a web 226 of crank arm material forming the base of each cavity.

The powermeter can be defined as two halves, an electronics module 233 received into the cavity in the inside face 222 of the crank arm, and a battery module 229 received into the cavity in the outside face 224 of the crank arm. As with the embodiment described with reference to FIG. 1, the crank arm inside face refers to the face towards the cycle frame and chainwheel, whilst the crank arm outside face refers to the face away from the frame and chainwheel. However, it will be appreciated that the modules may be mounted to the crank arm in the opposite positions to suit any preferred application. Having the battery module accessible from the outside crank arm face aids accessibility for changing or charging the batteries, and is therefore a preferred choice from a practical point of view. From a functional point of view, the modules can be placed into either cavity.

The electronics module 233 has an electronics board 231 that connects to the strain gauge(s) e.g. strain gauges 228a, 228b, preferably by hard wired soldered connections, though spring loaded or clip connections for wires from the strain gauges can be used. The electronics board 231 electrically and physically connects to a transmitter board 235.

Male 271 and female 273 electrical headers are used to connect the electronics board 231 and the transmitter board 235. The headers XXX and YYY are located towards one end of the boards and provide electrical contact and physical support for the transmitter board 235. One or more physical projections 237 (dimensioned to provide a matching separation distance between the electronics board 231 and the transmitter board 235 as determined by the assembled headers 271 and 273) are used to maintain preferred separation between the electronics and transmitter boards. These projections (or ‘standoffs’) help to stabilise the transmitter board and/or the electronics board to prevent physical distortion which can otherwise cause or introduce signal error from the strain gauges or in the signal passed to the transmitter from the electronics board.

Preferably the projection(s) or ‘standoff(s)’ 237 is/are off an electrically insulating plastic material, such as nylon. The or each projection can aid in levelling the separation between the two boards equivalent to the separation required for the electrical connection between those boards. Thus, an even separation is maintained.

A resilient material 241, such as a foam, can be provided between the cover 240 and the transmitter board 235. The resilient material applies a retaining pressure on the transmitter board without damaging or distorting that board. Thus, with the electronics module in place in the cavity and with the cover in place, a gentle retaining pressure is applied to the transmitter board and thus to the electronics board to help stabilise and steady thus boards and to cushion the electronics against physical shocks to the module.

Preferably the resilient material 241 is mounted over a spigot attached or forming part of inside of the cover 240 and which spigot passes through a central aperture in the transmitter board thereby physically locating the transmitter board in its required position.

A washer 243 is provided underneath the electronics board 231 between the electronics board and the web 226. The washer is preferably a double sided adhesive tape which provides a cushioning and insulation between the electronics board and the metal of the web.

On the battery or power module 229 side of the powermeter module, a retaining stud 251 has an externally threaded stud portion that extends through the web 226, through the washer 243 and through a central aperture in the electronics board 230 to engage with a threaded aperture in the spigot of the cover 240 of the electronics module. Thus, the electronics module is secured in place within the cavity.

The retaining stud 251 also has an internally threaded aperture on the battery module side. A locking device 253 prevents the threaded stud rotating beyond a preferred maximum torque within the spigot of the cover and thereby prevents stripping of one or both of the mutually engaging threads. The locking device preferably engages on a head portion of the threaded stud once the threaded stud is tightened up to a required amount. Preferably the fit is an interference fit. The locking device 253 a shown in FIG. 14 has a projecting arm that engages into or with a corresponding retaining portion on the battery cradle 252.

A bolt 238 passes through the battery cover 248 to engage into the internally threaded portion of the retaining stud 251. A circlip or E-clip 255 fits around the bolt to retain the bolt from the inside face of the cover and thereby prevent the bolt falling out and being lost. A bolt O-ring 257 provides a seal around the shaft of the bolt. In operation, when unwinding the bolt 238, a self-extracting force is applied to the battery cover 248 via the circlip 255 to make removal of the battery cover easier for the operator by helping to ease the o-ring seal and cover out of the cavity.

A light 259 is provided through the battery cover 248. Preferably the light is an LED provided within a light tube as shown. The light provides a visual indication of one or more states of the system, which may include battery power condition and can be controlled to indicate one or more faults or status of the powermeter, such as low battery power, electronics or transmitter faults etc or cadence triggering pulses.

A grounding connection 263, such as a metal spring helps to electrically ground the system to the web of the crank, and thereby the crank arm itself. An operating pair of crank arms is attached via a electrically conducting spindle (not shown) to thus provide a common electrical ground to the powermeters in each crank arm.

A spacer 261 is situated between the plate 254 of the battery module and the internal web of the crank arm. The spacer has a central aperture therethrough for the retaining stud 251 to pass through, and a cut-out to accommodate wires passing through the web from the battery module side to the electronics module side. The spacer helps to cushion the battery module against the web and to provide an even, stable surface to ensure reliable battery connections and performance of the module.

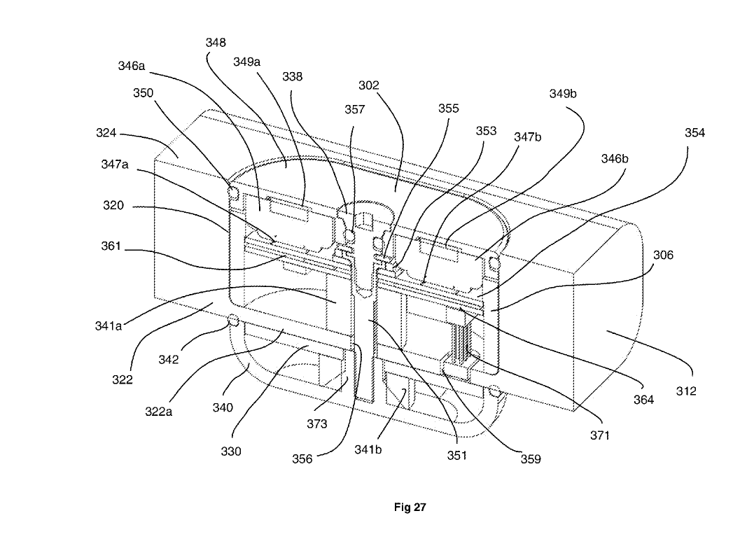

FIG. 27 shows an alternative form 302 of the present invention. The crank arm 312 includes a single sided cavity 320 to receive therein part of the power meter module 302. The electronics board (motherboard) 364 and power board 354 are housed within the cavity 320. Preferably, and as shown, the power board and electronics board are housed within the battery locator 306, though separate housings for the power board and the electronics board, and the battery locator, can be ‘stacked’ one onto the other (with suitable electrical connections therebetween)

Electrical connections 371 pass through an aperture 359 of the side wall 322a on the inside face 322 of the crank arm 312 to connect to an (RF) antenna board 330 protected by a cover 340.

A face seal 342 on the inside face 322 of the crank arm provides a weathertight seal to prevent ingress of moisture and dirt from the antenna side of the module.

A retaining stud 351 passes through another aperture 356 through the side wall 322a on the inside face 322 of the crank arm. The retaining stud 351 extends towards the power board 354 and electronics board 364 side of the power meter module and has an opening at an end thereof to receive the fastener 338 that retains the cover 348 over the power and electronics side of the module. The retaining stud 351 has one end fastened into a spigot 373 provided on the inside face of the cover 340 over the antenna. Thus, when the fastener 338 is tightened to retain the cover 348, the entire module is clasped together and the seals 342,350 prevent ingress of moisture and dirt.

Having the antenna at the inside face of the crank arm can beneficially aid signal transmission/reception across the frame of a cycle and/or to a display unit at the handlebars.

A standoff or spacer 341a supports the electronics 364 and power 354 boards away from inside face of the side wall 322a of the crank arm 312 formed by the base of the cavity 320. This standoff or spacer also provides a distancing piece to ensure the correct distance between connections on the electronics and (RF) antenna boards—thereby allowing for pin connections, although hard wired (soldered) connections are be preferred to reduce the risk of poor electrical connection over time, such as by corrosion or dirty contacts.

Another spacer 341b supports the antenna board 330, and is preferably of foam to apply a gentle resilient steadying pressure to the antenna board without distorting the board and otherwise causing poor signal transmission/reception.

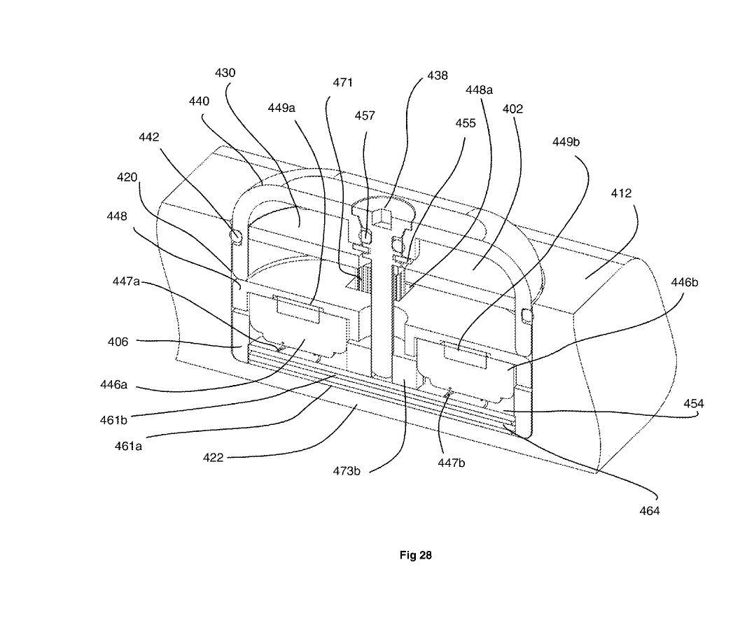

FIG. 28 shows an alternative embodiment of the present invention 402 utilising a single sided cavity 420 in the crank arm 412. However, in contrast to the embodiment described and shown with reference to FIG. 27, the embodiment shown in FIG. 28 has the antenna on the same side as the main opening into the cavity 420. Preferably the single cavity has its opening facing towards the inside face of the crank arm when in use i.e. the opening faces the cycle frame rather than facing outwards away from the cycle frame. However, an alternative embodiment can include the single sided cavity facing outwards away from the cycle frame when the crank arm is in use on the cycle.

The power board (motherboard) 464 and electronics board 454 are housed at the base of the cavity 420 and within the battery locator 406. Insulation layers 461a,461b are provided respectively between the side wall 422 and the electronics board 454, and between the electronics board and the power board 464.

A retainer spigot 473b receives and retains the fastener 438 which in turn clamps the entire module together. An O-ring seal 442 seals against the cavity side wall and prevents ingress of moisture and dirt into the module.

As can be seen in FIG. 28, the outer cover 440 applies pressure to the battery cover 448 when the fastener 438 is tightened. This positive pressure helps to ensure good electrical connection with and between the batteries.

Electrical connections 471 from the electronics board pass through an aperture 448a through the battery cover 448 for connection to the antenna board 430.

The single cavity and one side of the crank arm access to the power meter module of the present invention makes maintenance simple and efficient for users.

1-40. (canceled)

41. A crank arm including an elongate arm member having a first end arranged to connect to a crank axis and a second end arranged to receive an applied force to operate the crank arm, and at least one cavity provided in the crank arm member, the at least one cavity intermediate the first end and the second end and disposed towards a crank axis end of the crank arm relative to a pedal end of the crank arm, the at least one cavity extending into the crank arm member from a first cavity opening at a first external surface of the crank arm member, the at least one cavity arranged and configured to house electrical components of a powermeter, at least one of said components being accessible from the first cavity opening.

42. The crank arm according to claim 41, the crank arm being for a bicycle or other cycle.

43. The crank arm according to claim 41, the at least one cavity including at least one aperture connecting a first said cavity to a second said cavity in the crank arm member or connecting the first said cavity to a second external surface of the crank arm member.

44. The crank arm according to claim 41, the at least one aperture providing a passageway through a web or partial web or at least one rib or wall of material of the crank arm member for one or more electrical connectors to pass from one cavity portion to another cavity portion or to an external portion of the crank arm.

45. The crank arm according to claim 44, the crank arm member incorporating two said cavities, the first cavity extending from the first external surface of the crank arm and the second cavity extending from a second external surface of the crank arm member.

46. The crank arm according to claim 45, the two cavities connected by the web forming an I-beam arrangement in the crank arm.

47. The crank arm according to claim 44, the web or partial web or rib being on a neutral strain axis within crank arm member.

48. The crank arm according to claim 41, including a removable first cover to protect over the first cavity opening.

49. The crank arm according to claim 44, further including a removable second cover to protect over the second cavity opening, or both first and second covers to protect over the respective first and second cavity openings.

50. The crank arm according to claim 49, including a seal for each respective said removable cover.

51. The crank arm according to claim 50, the seal(s) being one or more of an O-ring or face seal or a combination of both for each said cover.

52. The crank arm according to claim 51, one or both of said first and second covers project(s) away from the crank arm.

53. The crank arm according to claim 49, one or both of the covers configured to house an antenna proud of the respective external surface of the crank arm.

54. The crank arm according to claim 41, including at least one strain gauge bonded to the internal surface of the at least one cavity.

55. The crank arm according to claim 54, including electrical connections from the stain gauge(s) to a plug and socket arrangement or hard wiring to processor circuitry.

56. The crank arm according to claim 54, the strain gauge(s) also bonded to a flexible or solid circuit board.

57. An electronics module configured to be housed in a crank arm having at least one cavity, the module including a first portion and a second portion, the first portion receivable into a first cavity opening in a first surface of the crank arm, the first cavity disposed towards a crank axis end of the crank arm relative to a pedal end of the crank arm, and the second portion receivable either into a second cavity opening in the first surface or into a second surface of the crank arm, or both the first and second portions receivable into a common cavity in the crank arm.

58. The module according to claim 57, the first portion of the module including electronics electrically connectable to or connected to at least one strain gauge mounted to an internal surface of the at least one cavity.

59. The module according to claim 57, the second portion of the module including a power supply arranged to power the electronics in the first module.

60. The module according to claim 57, the first module portion being hard wired to the second module portion or connected by plug and socket electrical connections.

61. The module according to claim 57, including at least one antenna operatively connected to a transmitter and/or receiver house in a part of the module.

62. The module according to claim 61, the antenna housed under a cover protecting at least one said portion of the module at one or both of the cavity openings.

63. The module according to claim 62, the cover proud of or flush with the envelope of the crank arm external surface such that the antenna is just below or outside of the external envelope of the crank arm surface.

64. The module according to claim 57, including a first cover over the first module portion when the first module portion is received into the cavity opening and a second cover over the second module portion when the second module portion is received into the second cavity opening.

65. The module according to claim 64, the first cover or the second cover or both the first and second covers retained by a releasable fastener arrangement.

66. The module according to claim 65, the releasable fastener arrangement includes one or more of a clip, catch, a resilient biasing means, one or more resilient portions or one or more threaded fasteners.

67. A cycle power meter system, including a crank arm having at least one cavity providing a first cavity with an opening on at least one side of the crank arm, the first cavity disposed towards a crank axis end of the crank arm relative to a pedal end of the crank arm, and the at least one cavity housing an electronics portion or a power supply portion of a powermeter module, or housing an electronics portion and a power supply portion of the powermeter module.

68. The system according to claim 67, the crank arm having the first cavity opening and a second cavity opening on opposed faces of the crank arm.

69. The system according to claim 68, the electronics portion received into the first cavity opening and the power supply portion received into the second cavity opening.

70. The system according to claim 69, the electronics portion and the power supply portion received into the first cavity opening.

71. The system according to claim 68, including a first said cavity from the first cavity opening and a second said cavity from the second cavity opening.

72. The system according to claim 71, the first and second cavities separated by a web of material of the crank arm.

73. The system according to claim 67, including an aperture through material of the crank arm from a first said cavity to a second said cavity or from the first said cavity to an exterior of the crank arm.

74. The system according to claim 73, including a portion of the powermeter module mounted at least partially externally of the crank arm, and electrical connections through the aperture to that portion of the power meter.

75. The system according to claim 67, provided pre-assembled with the powermeter module within the crank arm or as discrete parts for subsequent assembly.

76. The system according to claim 67, the system including a pair of crank arms, both said crank arms grounded to a common earth.
